(19) United States
(12) Patent Application Publication
(10) Pub. No.: US 2026/0296503 A1
(43) Pub. Date: Oct. 1, 2026

(54) SYSTEM FOR RECOGNIZING AND TRACKING OBJECT BY USING ARTIFICIAL INTELLIGENCE AND AUTONOMOUS DRIVING SENSOR AND METHOD IMPLEMENTING THE SAME

(71) Applicants: Hyundai Motor Company, Seoul (KR); Kia Corporation, Seoul (KR)

(72) Inventor: Won Je JANG, Hwaseong-Si (KR)

(21) Appl. No.: 19/331,587

(22) Filed: Sep. 17, 2025

(30) Foreign Application Priority Data
Mar. 25, 2025 (KR) 10-2025-0038201

(51) Int. Cl. B60W 60/00; B60W 40/04; B60W 50/00; G06T 7/246; G06V 20/58

(52) U.S. Cl. CPC B60W 60/00272; B60W 40/04; B60W 50/0098; G06T 7/246; G06V 20/58; B60W 2050/0022; B60W 2420/408; B60W 2554/4041; B60W 2554/4042; B60W 2556/45; G06T 2207/30261

(57) ABSTRACT

An apparatus of a host vehicle may comprise a processor and a memory storing at least one instruction that, when executed by the processor communicating with the memory, is configured to cause the apparatus to obtain multiple point data input from a sensor of the host vehicle, detect and track a vehicle in a surrounding environment of the host vehicle using an artificial intelligent model, determine whether a movement of the vehicle satisfies a normal condition or a special condition, execute one of a first displacement estimation process or a second displacement estimation process, output a signal indicating updated displacement information and velocity information for the vehicle, and control, based on the signal, autonomous driving of the host vehicle.

### CROSS-REFERENCE TO RELATED APPLICATION

This application claims the benefit of priority to Korean Patent Application No. 10-2025-0038201, filed with the Korean Intellectual Property Office on Mar. 25, 2025, the entire contents of which are incorporated herein by reference.

### TECHNICAL FIELD

The present disclosure relates to a system and method for recognizing and tracking an object using an artificial intelligence (AI) module and an autonomous driving sensor, and more particularly, to a system and method for applying a displacement measurement method that is optimized according to a current driving situation of the object in response to a case where the object is a vehicle, thereby stably tracking a velocity of the object regardless of the driving situation.

### BACKGROUND

The matters described in this Background section are only for enhancement of understanding of the background of the disclosure, and should not be taken as acknowledgment that they correspond to prior art already known to those skilled in the art.

With the development and commercialization of autonomous vehicles, the use of various sensors and artificial intelligence (AI) technologies to support autonomous driving functions of vehicles is increasing. For example, research is ongoing into what object exists in front of a moving vehicle, what the distance is between the object and the vehicle, and what algorithm the vehicle should use to respond to specific situations to ensure safety.

Accordingly, vehicle sensor technology is becoming more advanced, and high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) are being installed in a vehicle.

As above, by aggregating measurement results obtained from a plurality of sensors, it has become possible to implement a super sensor vehicle. In self-driving (autonomous driving), concept of a super sensor refers to a technology that seeks to more accurately recognize the surrounding environment by combining measurements from various sensors rather than relying on individual sensors for convenience and safety of driving. With the addition of information and communications technology (ICT) and cloud technology, sensors and AI algorithms required for autonomous driving are becoming more sophisticated than ever before, not only for a single vehicle, but also for a fleet of vehicles, remotely accumulating data and training AI servers and databases to increase reliability of vehicle sensor determination.

Among these, a LIDAR sensor, used to recognize external environments, emit lasers and measure a time it takes for reflection and intensity of the reflected lasers, thereby identifying various objects present on the road during autonomous driving.

Object recognition using a LiDAR and an AI algorithm may not be perfect. A technology to accurately recognize and track an object is considered.

### SUMMARY

The present disclosure relates to a system and method for recognizing and tracking an object using an artificial intelligence (AI) module and an autonomous driving sensor, and more particularly, a main technical task is to implement a system and method capable of stably tracking a velocity of an object regardless of a driving situation by applying a displacement measurement method that is optimized for a current driving situation of the object when the object is a vehicle.

Of course, the technical problems of the present disclosure are not limited to the technical problems mentioned above, and other technical problems not explicitly mentioned will be clearly understood by those skilled in the art from the detailed description of the present disclosure and the attached drawings.

In order to solve all or at least part of the above-described technical problems, the present disclosure may be implemented in various examples as follows.

According to the present disclosure, an apparatus of a host vehicle, the apparatus may comprise, a processor, and a memory storing at least one instruction that, when executed by the processor communicating with the memory, is configured to cause the apparatus to, obtain multiple point data input from a sensor of the host vehicle, based on the multiple point data and using an artificial intelligent model, detect and track a vehicle in a surrounding environment of the host vehicle, determine whether a movement of the vehicle satisfies a normal condition or a special condition, based on the determination of whether the movement satisfies the normal condition or the special condition, execute one of a first displacement estimation process or a second displacement estimation process, wherein the first displacement estimation process is performed to determine a displacement of the vehicle under the normal condition, and wherein the second displacement estimation process is performed to determine a displacement of the vehicle under the special condition, based on a displacement of the vehicle determined by the execution of the one of the first displacement estimation process or the second displacement estimation process, output a signal indicating updated displacement information and velocity information for the vehicle, and control, based on the signal, autonomous driving of the host vehicle.

The apparatus, wherein the at least one instruction, when executed by the processor communicating with the memory, is configured to cause the apparatus to, based on a determination that the movement of the vehicle satisfies the normal condition, determine whether a velocity of the vehicle exceeds a predetermined range, based on a determination that the velocity of the vehicle exceeds the predetermined range, execute an additional displacement estimation process, and based on the execution of the additional displacement estimation process, update displacement information and velocity information for the vehicle.

The apparatus, wherein the special condition is at least one of, a first type in which the vehicle moves across a field of view (FOV), a second type in which the vehicle accelerates or decelerates at a rate greater than a preset threshold acceleration or deceleration value, respectively, a third type in which the vehicle is moving laterally, a fourth type in which the vehicle rotates and progresses, or a fifth type in which the vehicle is moving diagonally.

The apparatus, wherein the second displacement estimation process is configured to, based on the special condition being the first type, determine a displacement of the vehicle using a point at an upper side of a side surface of a predicted bounding box (P-Box) associated with the vehicle when the vehicle is an object closest to the sensor. The apparatus, wherein the second displacement estimation process is configured to determine a displacement of the vehicle based on a rear point of a predicted bounding box (P-Box) associated with the vehicle.

The apparatus, wherein the second displacement estimation process is configured to, based on, the special condition being the second type, a velocity value updated by the execution of the second displacement estimation process deviating from a predetermined threshold, and velocity information and slope information of the vehicle at a time point before the velocity value exceeding the predetermined threshold, adjust the velocity value that exceeds the predetermined threshold such that the adjusted velocity value falls within the predetermined threshold.

The apparatus, wherein the second displacement estimation process is configured to, based on, the special condition being the second type, an absolute velocity value updated by the execution of the second displacement estimation process being zero meters per second (mps) or less, and velocity information and slope information of the vehicle at a time point before the absolute velocity value being zero mps or less, adjust the absolute velocity value that is zero mps or less such that the adjusted absolute velocity value exceeds zero mps.

The apparatus, wherein the second displacement estimation process is configured to, based on a point, among points forming vertices of a predicted bounding box (P-Box) for the vehicle, that is closest and most stable to a virtual line extending through a center of the vehicle, determine a displacement of the vehicle, wherein the sensor is in a front driving direction of the vehicle, and wherein the special condition is one of the third type, the fourth type, and the fifth type. The apparatus, wherein a velocity Vₜ at a current time point t, updated by the one of the first displacement estimation process or the second displacement estimation process, is determined according to Equation 1,

$${V}_{t} = mean ( {V}_{t - n : t - 1} ) \times α + {\hat{V}}_{t} \times ( 1 - α ) \qquad [ Equation 1 ]$$

wherein, \hat{V}ₜ indicates a current velocity determined based on displacement, mean(V_{t-n:t-1}) indicates an average velocity at a previous time point (t−1), n indicates a number of velocity computations performed for average velocity determination, and α indicates a velocity update ratio at the previous time point (t−1) and is a value between 0 and 1. The apparatus, wherein the first displacement estimation process is configured to, based on a rear center point relative to a travel direction of the vehicle and the velocity update ratio being set to 0.2, measure a displacement of the vehicle.

According to the present disclosure, a method performed by an apparatus of a host vehicle, the method may comprise, obtaining multiple point data input from a sensor of the host vehicle, based on the multiple point data and using an artificial intelligent model, detecting and tracking a vehicle in a surrounding environment of the host vehicle, determining whether a movement of the vehicle satisfies a normal condition or a special condition, based on the determining of whether the movement satisfies the normal condition or the special condition, executing one of a first displacement estimation process or a second displacement estimation process, wherein the first displacement estimation process is performed to determine a displacement of the vehicle under the normal condition, and wherein the second displacement estimation process is performed to determine a displacement of the vehicle under the special condition, based on a displacement of the vehicle determined by the execution of the one of the first displacement estimation process or the second displacement estimation process, outputting a signal indicating updated displacement information and velocity information for the vehicle, and controlling, based on the signal, autonomous driving of the host vehicle.

The method may further comprise, based on a determination that the movement of the vehicle satisfies the normal condition, determining whether a velocity of the vehicle exceeds a predetermined range, based on a determination that the velocity of the vehicle exceeds the predetermined range, executing an additional displacement estimation process, and based on the execution of the additional displacement estimation process, updating displacement information and velocity information for the vehicle.

The method, wherein the special condition is at least one of, a first type in which the vehicle moves across a field of view (FOV), a second type in which the vehicle accelerates or rapidly decelerates at a rate greater than a preset threshold acceleration or deceleration value, respectively, a third type in which the vehicle is moving laterally, a fourth type in which the vehicle rotates and progresses, or a fifth type in which the vehicle is moving diagonally. The method may further comprise, determining, based on the second displacement estimation process, a displacement of the vehicle using a point at an upper side of a side surface of a predicted bounding box (P-Box) associated with the vehicle when the vehicle is an object closest to the sensor, wherein the special condition is the first type.

The method may further comprise, determining, based on the second displacement estimation process, a displacement of the vehicle based on a rear point of a predicted bounding box (P-Box) associated with the vehicle. The method may further comprise, based on, the special condition being the second type, a velocity value updated by the execution of the second displacement estimation process deviating from a predetermined threshold, and velocity information and slope information of the vehicle at a time point before the velocity value exceeding the predetermined threshold, adjusting the velocity value that exceeds the predetermined threshold such that the adjusted velocity value falls within the predetermined threshold. The method may further comprise, based on, the special condition being the second type, an absolute velocity value updated by the execution of the second displacement estimation process being zero meters per second (mps) or less, and velocity information and slope information of the vehicle at a time point before the absolute velocity value being zero mps or less, adjusting the absolute velocity value that is zero mps or less such that the adjusted absolute velocity value exceeds zero mps.

According to the present disclosure, a vehicle may comprise, a sensor, a driving control circuit configured to control autonomous driving of the vehicle, a processor, and a memory storing at least one instruction that, when executed by the processor communicating with the memory, is configured to cause the vehicle to, obtain point cloud data from the sensor representing a surrounding environment of the vehicle, identify an object in the surrounding environment of the vehicle based on the point cloud data using an artificial intelligence model, identify a movement condition of the object as either, a normal condition, in which the object travels forward along a travel direction with a velocity and a heading that remain within a predetermined range over a time period, or a special condition, in which at least one of a velocity or a heading of the object deviates from the predetermined range within the time period, based on the identified movement condition, execute a displacement estimation process specific to the identified movement condition to determine a displacement and a velocity of the object, output a signal indicating the displacement and the velocity of the object, and control, based on the signal, autonomous driving of the vehicle using the driving control circuit.

The vehicle, wherein the at least one instruction that, when executed by the processor communicating with the memory, is configured to cause the vehicle to, select, based on the identified movement condition, a representative point of a predicted bounding box of the object from which the displacement is determined, wherein, in the normal condition, the representative point is a rear center point of the predicted bounding box, and wherein, in the special condition, the representative point is a point, among vertices of the predicted bounding box, closest to a center line of the vehicle in a front driving direction.

The vehicle, wherein the at least one instruction that, when executed by the processor communicating with the memory, is configured to cause the vehicle to, based on a sum of a previously determined average velocity of the object and a current velocity of the object, determine the velocity of the object, wherein the current velocity is derived, based on a weighting factor, from a displacement of the object, wherein, in the normal condition, the weighting factor is set to a first value, and wherein, in the special condition, the weighting factor is set to a second value that is smaller than the first value.

Furthermore, various effects in addition to effects described above from the present disclosure by those skilled in the art are provided through the detailed description of the present disclosure and the attached drawings.

### BRIEF DESCRIPTION OF THE DRAWINGS

FIG. 1 shows an example overall system for automatically recognizing objects and controlling a vehicle for purposes such as autonomous driving.

FIG. 2 shows an example overall AI object tracking algorithm 200 that considers a driving situation.

FIG. 3A, FIG. 3B, FIG. 3C, FIG. 3D, and FIG. 3E shows exemplary algorithms for determining several special driving situations.

FIG. 4A and FIG. 4B show example views for describing a method for determining a special driving situation of rapid acceleration and deceleration.

FIG. 5 shows an example of a method by which a representative point used for displacement computation of an object changes in a special driving situation in which the object is traveling in a horizontal direction.

FIG. 6 shows an example method of selecting a representative point used for displacement computation of an object in a general driving situation.

FIG. 7 shows an example method of selecting a representative point used for displacement computation of an object in some special driving situations.

FIG. 8A and FIG. 8B show an example method for correcting a velocity determination error that may occur for an object undergoing rapid acceleration or deceleration.

FIG. 9 shows an exemplary experimental result showing that tracking performance for a horizontal velocity of an object is improved in a case where an example of the present disclosure is actually applied.

FIG. 10 shows an example computing system for autonomous vehicle control and object recognition computation.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing examples of the present disclosure, in a case where it is determined that detailed descriptions of related well-known configurations or functions interfere with understanding of the examples of the present disclosure, the detailed descriptions thereof will be omitted.

In describing constituent elements according to various examples of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ essentially holds same meaning as ‘entity,’ and the expressions ‘object’ and ‘entity’ will be interchangeably used throughout the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of tailored displacement and velocity update for special driving situations) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of tailored displacement and velocity update for special driving situations) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of tailored displacement and velocity update for special driving situations) described herein.

Minimum risk maneuver (MRM) operation(s) may also be controlled, for example, based on one or more features (e.g., features of tailored displacement and velocity update for special driving situations) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of tailored displacement and velocity update for special driving situations) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of tailored displacement and velocity update for special driving situations) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of tailored displacement and velocity update for special driving situations) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The present disclosure relates to an apparatus and method for improving object recognition and tracking in autonomous driving environments by utilizing an artificial intelligence (AI) model and sensor data from sensors such as LiDAR. The disclosed apparatus and method may determine whether a driving situation involving an object (e.g., a vehicle) corresponds to a normal or special condition, such as sudden acceleration or deceleration, lateral movement, rotational movement, diagonal movement, or motion across a sensor's field of view. Based on this determination, the apparatus may apply a displacement estimation process specifically tailored to the identified condition. This tailored approach enables more robust tracking of the object's displacement and velocity, even under rapidly changing conditions, by dynamically selecting representative points and applying adaptive update logic. As a result, the disclosed apparatus and method may reduce velocity estimation errors and enhance the stability and accuracy of object tracking in autonomous driving scenarios.

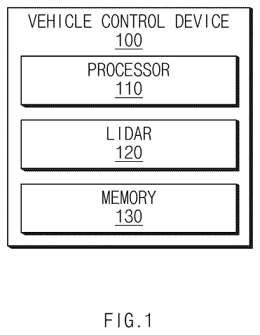

FIG. 1 shows an example shows an example overall system for automatically recognizing objects and controlling a vehicle for purposes such as autonomous driving.

Referring to FIG. 1, a vehicle control apparatus 100 according to an example of the present disclosure may be implemented inside or outside a vehicle, and some of the components included in the vehicle control apparatus 100 may be implemented inside or outside the vehicle. In the instant case, the vehicle control apparatus 100 may be integrally formed with internal control units of the vehicle, or may be implemented as a separate device to be connected to control units of the vehicle by a separate connection means. For example, the vehicle control apparatus 100 may further include components (e.g., a GPS circuit, a vehicle communication interface, or a power management circuitry, etc.) not shown in FIG. 1.

The vehicle control apparatus 100 according to an example may include a processor 110, a LiDAR 120, and a memory 130. The processor 110, the lidar 120, or the memory 130 may be electronically and/or operably coupled with each other by an electronic component including a communication bus.

Hereinafter, hardware components being operatively coupled may include a direct connection, and/or an indirect connection established between the components, wired, and/or wireless, such that a second component is controlled by a first component among the components.

Although they are illustrated in different blocks, the examples are not limited thereto. For example, some of the hardware components in FIG. 1 may be included in a single integrated circuit including a system on a chip (SoC). A type and/or number of hardware components included in the vehicle control apparatus 100 is not limited to that shown in FIG. 1. For example, the vehicle control apparatus 100 may include some of the components illustrated in FIG. 1.

The vehicle control apparatus 100 according to an example may include hardware for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may be configured to have a single-core processor structure, or a multi-core processor structure including dual core, quad core, hexa core, or octa core (e.g., depending on the computational complexity of perception models, route planning, or control logic, etc.).

According to another example, the processor 110 may be configured to include at least one of a graphic processing unit (GPU), a neural processing unit (NPU), or any combination thereof. For example, the GPU may be referred to as a visual processing unit (VPU). For example, the NPU may be referred to as a neural network processing unit (e.g., enhanced or optimized for running convolutional neural networks, transformer models, or sensor fusion algorithms, etc.).

The vehicle control apparatus 100 according to an example may include a depth sensor for detecting external objects. For example, the depth sensor for detecting external objects may include at least one of a time of flight (ToF) sensor, a light detection and ranging (LiDAR) 120, a structured light sensor, an ultrasonic sensor, an infrared sensor, a radio detection and ranging (RADAR), an optical distance sensor, or any combination thereof (e.g., combining LiDAR and RADAR to improve robustness in low-visibility conditions, etc.). Hereinafter, for better understanding and ease of description, a description will focus on the LiDAR.

The vehicle control apparatus 100 according to an example may include a LiDAR 120 that acquires a plurality of points based on a pulse laser signal. For example, the LiDAR 120 may acquire data sets that identify objects surrounding the vehicle control apparatus 100 (or a vehicle including the vehicle control apparatus 100). For example, the LiDAR 120 may identify at least one of a position, a moving direction, a velocity, or any combination thereof of a surrounding object based on the pulse laser signal emitted from the LiDAR 120 being reflected back by the surrounding object (e.g., a nearby vehicle, a pedestrian, a tree, or a building, etc.).

For example, the LiDAR 120 may obtain data sets representing external objects in a space formed by an x-axis, a y-axis, and a z-axis based on the pulse laser signal reflected from the surrounding object. For example, the LiDAR 120 may acquire data sets including a plurality of points in the space formed by the x-axis, the y-axis, and the z-axis based on receiving the pulse laser signal every designated period (e.g., every 100 milliseconds, every sensor frame, or at a refresh rate of 10 Hz, etc.). For example, the points may include points representing external objects within a 3D virtual coordinate system. The 3D virtual coordinate system may include at least one of a vehicle coordinate system, a LIDAR coordinate system, or any combination thereof. However, an example of the 3D virtual coordinate system is not limited to those described above (e.g., it may include a world coordinate system or a map-based coordinate system, etc.).

The memory 130 of the vehicle control apparatus 100 according to an example may include hardware component for storing data and/or instructions input to and/or output from the processor 110 of the vehicle control apparatus 100. For example, the memory 130 may include a volatile memory including a random-access memory (RAM), and/or a nonvolatile memory including a read-only memory (ROM).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof (e.g., depending on cost, size, write endurance, or access speed, etc.).

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application (e.g., an object detector, a SLAM module, or a LiDAR segmentation engine, etc.).

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100) (e.g., a binary executable file, or a compiled library, etc.).

For example, the memory 130 may include a first neural network model for detecting an object. For example, the memory 130 may include a second neural network model for outputting types of the points acquired by the lidar 120 and/or scores of the points (e.g., object class scores or distance likelihoods, etc.).

In an example, the processor 110 may be configured to obtain at least one of a first virtual box representing a target object, a first class representing a type of the target object, or any combination thereof, based on the points acquired through the LiDAR 120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model (e.g., a 3D bounding box detector or a center-based detection network, etc.). For example, the target object may include an external object positioned within a designated distance from the vehicle control apparatus 100 (or a vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include multiple types for classifying the target object. For example, the type of the target object may include at least one of a first type representing a ground, a second type representing a type that is different from the ground, or any combination thereof. However, the type of the target object is not limited to what was described above. For example, the type of the target object may include at least one of a third type representing a person, a fourth type representing a vehicle, or any combination thereof (e.g., a bicycle, a traffic cone, a tunnel wall, or a construction sign, etc.), but the present disclosure is not limited thereto.

In an example, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model may include a segmentation model (e.g., a range-view CNN, a point-based classifier, or a sparse voxel network, etc.).

For example, the second neural network model may include a neural network model for obtaining types of multiple points and scores of the points (e.g., softmax outputs, probability heatmaps, or class activation scores, etc.).

For example, the processor 110 may be configured to obtain first partial points corresponding to at least a portion of the target object among the points based on inputting the points into the second neural network model. For example, the processor 110 may be configured to identify the types of the points based on inputting the points into the second neural network model. For example, the processor 110 may be configured to obtain first partial points corresponding to at least a portion of the target object from among the points based on the type of each of the points (e.g., classifying some points as belonging to a vehicle, pedestrian, or roadside object, etc.).

In an example, the processor 110 may be configured to perform a first designated algorithm on the points. For example, the processor 110 may be configured to perform the first designated algorithm for classifying a type of each of the points for the points, for example, within the LiDAR data frame. For example, the processor 110 may be configured to classify second partial points corresponding to a designated type among the points. For example, the designated type may include a type representing the ground (e.g., pavement, crosswalks, or flat surfaces, etc.).

For example, the processor 110 may be configured to classify the second partial points corresponding to a designated type based on performing the first designated algorithm on the points and obtain (or identify) the first partial points by excluding the second partial points from among the points (e.g., separating above-ground structures from terrain, etc.).

For example, the processor 110 may be configured to obtain at least one of a partial class for obtaining a second class, a score for each of the points, or any combination thereof, based on inputting the points into the second neural network model. For example, the processor 110 may be configured to obtain a partial class and a score for each of the points based on inputting the points into the second neural network model. For example, the partial class may contain a classification of each of the points into an arbitrary type (e.g., tree, vehicle, pedestrian, or unknown, etc.).

For example, the processor 110 may be configured to fuse the partial class, the scores of each of the points, and the second partial points (e.g., for joint feature enhancement or confidence weighting, etc.). For example, the processor 110 may be configured to perform clustering based on fusing the partial class, the scores of each of the points, and the second partial points. For example, the clustering may involve grouping first partial points that correspond to at least a portion of the target object (e.g., to generate an instance-level region for bounding box generation, etc.).

For example, the processor 110 may be configured to obtain a point cloud for generating a second virtual box based on the first partial points. For example, the processor 110 may be configured to obtain the point cloud based on grouping the first partial points (e.g., using spatial proximity, density thresholding, or Density-Based Spatial Clustering of Applications with Noise (DBSCAN), etc.).

For example, the processor 110 may be configured to generate a second virtual box, different from the first virtual box and for representing the target object, based on the point cloud. For example, the second virtual box may include a box that includes at least some of the first partial points (e.g., tightly fitted to the object's spatial extent, etc.).

For example, the processor 110 may be configured to identify a heading direction indicating a traveling direction of the target object based on at least one of the first partial points, the point cloud, or any combination thereof (e.g., using temporal point shifts or bounding box orientation, etc.).

For example, the processor 110 may be configured to identify a position of a second virtual box in a virtual coordinate system based on at least one of the first partial points, the point cloud, or any combination thereof (e.g., by computing the centroid of the clustered points, using a bounding box anchor, or referencing vehicle-relative coordinates, etc.). For example, the processor 110 may be configured to identify a size of the second virtual box based on at least one of the first partial points, the point cloud, or any combination thereof (e.g., by estimating width, height, and depth based on point dispersion or statistical spread, etc.).

For example, the processor 110 may be configured to identify a second class based on at least one of the first partial points, the point cloud, or any combination thereof (e.g., classifying as car, pedestrian, traffic cone, or unknown, etc.). For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof (e.g., to aid in trajectory prediction, collision risk estimation, or classification confidence, etc.).

For example, the processor 110 may be configured to identify the heading direction of the bounding box based on at least one of the first virtual box, the first class, the heading direction of the second virtual box, the position of the second virtual box, the size of the second virtual box, the second class, or any combination thereof (e.g., by tracking box orientation over time, using direction vectors, or aligning with lane markings, etc.). For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof (e.g., using Kalman filtering, relative coordinate mapping, or GPS reference data, etc.).

For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof (e.g., refining classification using fusion from multiple frames, object hierarchy rules, or semantic context, etc.). For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof (e.g., for generating object tracks, scene graphs, or vehicle control cues, etc.).

For example, the processor 110 may be configured to assign a first identifier to the second virtual box for tracking the second virtual box (e.g., a unique ID based on timestamp, class, or location hash, etc.). For example, the processor 110 may be configured to assign a second identifier corresponding to the first identifier to the bounding box (e.g., to maintain identity consistency between detection and tracking outputs, etc.).

For example, the processor 110 may be configured to track the bounding box using the second identifier. For example, the processor 110 may be configured to track the target object based on identifying a plurality of bounding boxes that include a bounding box to which the second identifier is assigned, in a plurality of frames (e.g., through temporal association or object re-identification, etc.). For example, the second identifier may be identifier assigned to a bounding box corresponding to the target object, so the processor 110 may be configured to track the target object by identifying the bounding boxes to which the second identifier is assigned in the frames (e.g., over multiple sensor cycles or time steps, etc.).

In an example, the processor 110 may be configured to output a bounding box corresponding to the target object based on at least one of the first virtual box, the first class, the first partial points, the second class, or any combination thereof (e.g., as a hexahedral 3D box, 2D projected box, or directional polygon, etc.). For example, the bounding box may include an example of the target object represented in the virtual coordinate system in the form of a hexahedron (e.g., defined by eight corner points in 3D space, etc.).

Hereinafter, operations performed by a CPU, a GPU, and/or a NPU included in the processor 110 will be briefly described.

In an example, the processor 110 may be configured to include at least one of a CPU, a GPU, an NPU, or any combination thereof. For example, at least one of the GPU, the NPU, or any combination thereof may obtain the first virtual box and the first class based on the first neural network model (e.g., a region proposal network, transformer-based model, or YOLO-like detector, etc.). For example, at least one of the GPU or the NPU may acquire the first virtual box and the first class. For example, at least one of the GPU, the NPU, or any combination thereof may obtain scores for each of the partial classes and the points for obtaining the second class based on the second neural network model. For example, at least one of the GPU or the NPU may obtain scores for each of the partial classes and the points for obtaining the second class based on the second neural network model (e.g., probability distributions over semantic labels, etc.). For example, the CPU may classify second partial points corresponding to a designated type among the points based on performing the first designated algorithm for classifying types of each of the points for the points (e.g., such as distinguishing ground, non-ground, or noise points, etc.).

As described above, the vehicle control apparatus 100 according to an example may be configured to include at least one processor 110. The vehicle control apparatus 100 may be configured to accurately detect a target object by detecting the target object using at least one processor 110. Additionally, by performing parallel processes, the vehicle control apparatus 100 may be configured to reduce a load on each processor (e.g., enabling real-time LiDAR segmentation and object tracking, etc.).

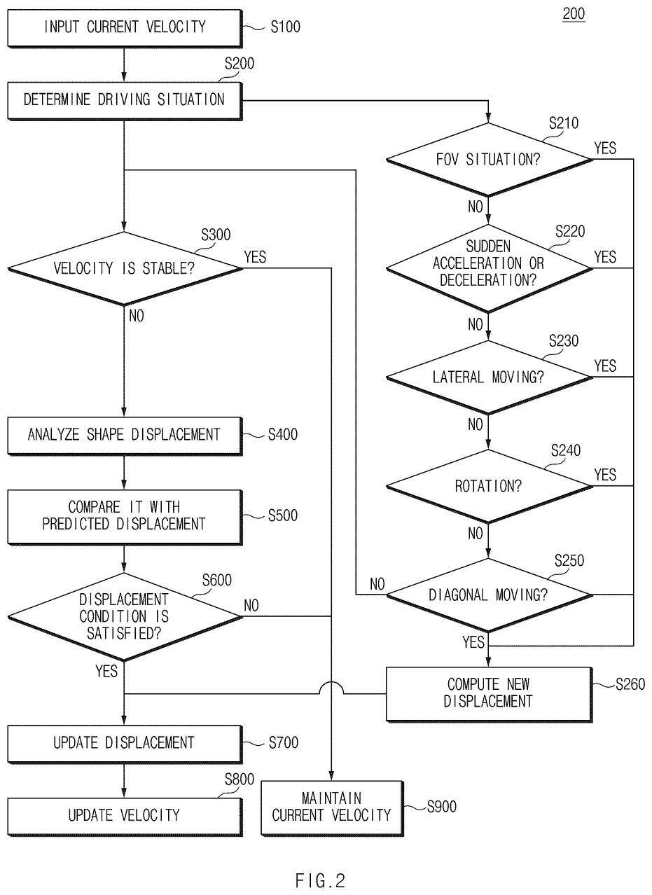

Before describing FIG. 2, a following description is added to provide a comprehensive understanding of AI object recognition according to the present disclosure, specifically regarding LiDAR-based object recognition.

An object recognition process by the LiDAR 120 and an AI module may go through three operations: preprocessing, segmentation, and tracking. For example, AI module may include and execute one or more AI models (e.g., neural networks) for object recognition and segmentation in point cloud data (e.g., LiDAR point cloud data).

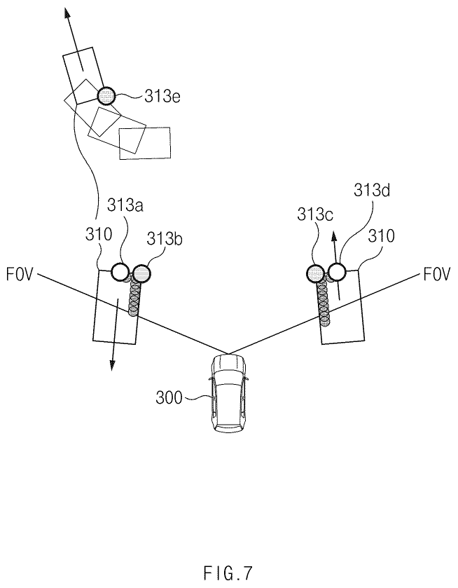

An object recognition system 1000 (see FIG. 7) according to the present disclosure goes through a preprocessing process before executing the object recognition function. The preprocessing may include, e.g., removing points forming the ground based on laser sensing data (i.e., unprocessed raw data) input from the LIDAR 120. A laser beam reflected from ground may be mistakenly recognized as if there is an object on the ground, so a process of distinguishing between the ground and non-ground may be performed in a preprocessing operation, and if necessary, may also be performed in a segmentation operation.

In short, the preprocessing in AI object recognition may be understood as a process in which an image processing tool of the AI module in a processor 110 removes noise from a LIDAR point cloud image and reduces a total number of points existing in the LiDAR point cloud image through, for example, a voxel downsampling technique, random sampling, range filtering, or grid-based clustering, etc., to improve a computational efficiency.

For reference, a LIDAR point cloud image may also be displayed in a bird's eye view (BEV) mode. In a case where a LIDAR map is created to resemble a bird's eye view of a city while flying in the sky, such maps are called a BEV image.

For example, as described above, the LiDAR 120 may emit a laser beam into a surrounding environment, record a time it takes for the laser beam to be reflected by an external object and returns, thereby generating a point each of numerous laser signals and determining a distance to that point. By continuously emitting numerous laser beams, the processor 110 may be configured to generate a real-time LiDAR map of the surrounding environment as a three-dimensional map of the BEV type (e.g., for parking assistance, collision avoidance, or lane detection, etc.), and as a two-dimensional map in specific cases (e.g., flat terrain mapping or 2D occupancy grids, etc.).

In the LiDAR point cloud map, the lines or surfaces appearing in black and white may actually be formed of an innumerable number of points, each of which is generated by the laser beams of the LiDAR 120, and for this reason, a LiDAR sensing image is also referred to as a LIDAR point cloud image. Of course, for example, by combining an RGB-D (Red, Green, Blue-Depth) sensor with a LiDAR sensor, a LIDAR point cloud image may be reconstructed in color (e.g., to distinguish pedestrians, traffic cones, lane markings, or buildings, etc.).

It is challenging for a human to recognize objects using individual points within a LIDAR point cloud image; however, by synthesizing the point cloud from perspectives such as a BEV or 2D plan view, it may become possible to roughly estimate appearance of the surrounding environment of the vehicle currently in an autonomous driving mode. Furthermore, it may be possible to recognize a vehicle, a bus, a pedestrian, a street tree, a traffic cone, a motorcycle, a traffic sign, or a bicycle, etc. within the LiDAR point cloud image, and in AI image recognition technology, these human and things are referred to as objects, and each object may be classified into a specific group, known as a class, such as a vehicle class, a bus class, a pedestrian class, or a tree class, etc.

Distinguishing which object in the LiDAR point cloud image belongs to the vehicle class or the bus class may require assistance of a deep AI neural network. To detect objects within the LiDAR point cloud image through the AI neural network and identify their classes, AI training may have to be conducted beforehand, for example, using labeled datasets, data augmentation, transfer learning, or synthetic simulation data, etc.

For example, the dataset called PANDASET™ may include over 48,000 camera images (mostly taken in the Silicon Valley area of the United States) and more than 16,000 LIDAR scan images, which are annotated with a total of 28 classes, including pedestrians, passenger vehicles, bicycles, construction site signs, and traffic signs (e.g., stop signs, yield signs, or speed limit indicators, etc.).

Furthermore, an LiDAR point cloud image may be visualized according to a user-selected option using a point cloud processing tool such as Open3D™. The LIDAR 120 may be capable of distance detection, so a 3D LiDAR image may be rendered more realistically during visual processing with a tool like Open3D™, and for instance, an object at a greater distance may be displayed in dark blue, while a closer object may be shown in light blue (e.g., for enhanced depth perception and visualization clarity, etc.).

Furthermore, as mentioned above, an original LiDAR image (i.e., raw data) may be preprocessed by applying a technique called voxel (3D pixel) downsampling to the LiDAR point cloud image. Herein, a voxel (volumetric pixel) refers to a cube-shaped 3D pixel, and the voxel down-sampling may be a technique used to reduce a number of points in the LiDAR point cloud while maintaining structures of various objects included therein, but reducing or minimizing an excessive computation requirement (e.g., AI computational requirement to enable faster training or inference, or to match GPU memory constraints, etc.).

The LiDAR 120 may emit m laser beams n times during a single scan cycle, and scan values of the laser beams that collide with and return from external objects form an (m×n) matrix, which is referred to as a range image. Each point in the LiDAR point cloud image may include depth (i.e., range) information, as well as additional details such as intensity, azimuth, inclination, and other additional information of returned laser pulse (e.g., pulse width, timestamp, or number of returns, etc.). Range images may be used for AI training with large datasets, such as Waymo™ Open Dataset (WOD).

Range view (RV) refers to a technique that converts 3D point clouds into 2D or 2.5D scenes, allowing LiDAR 3D maps to be represented in a way that is more intuitively understandable to humans, resembling an analog drawing rather than a collection of countless points. In a range view image, a 3D LiDAR point cloud image may have 2D coordinates, but a 3D laser-related information (angle, inclination, intensity, etc.) recorded in response to obtaining the range image may not be discarded (e.g., enabling the network to retain geometric fidelity despite dimensionality reduction, etc.). A 3D LiDAR image's (x, y, z) coordinates may be transformed into a 2D range view image by applying a width variable to the (x, y) coordinates to obtain the coordinates of one axis in two dimensions and applying a height variable and range image information indicating a range (depth) to the (z) coordinate to obtain the coordinates of another axis in two dimensions.

Furthermore, the AI algorithm according to the present disclosure may include a convolutional neural network (CNN), which is an AI training module frequently used to extract features (or feature points) from image data. For this purpose, there are commercially available datasets including tens of thousands of images, and CNNs currently exist in versions that can process images from one-dimensional to three-dimensional (e.g., 1D signal processing, 2D camera images, or 3D volumetric data from LiDAR, etc.). For example, a result of a range view image processing tool is trained by a CNN neural network to perform a function of helping AI accurately recognize objects in an image.

Objects around autonomous vehicles may be ultimately recognized by machines, so an action of generating a ground truth (GT) bounding box on the aforementioned LiDAR map may also be a critical step in object recognition. In machine learning, GT (ground truth) is a term used to indicate an original or actual value of data that AI is trying to learn. Typically, a bounding box with a box-shaped boundary may be considered a type of image annotation applied to a LiDAR point cloud image (e.g., for identifying cars, pedestrians, bicycles, or lane markers, etc.).

For example, the AI module may retrieve labels to recognize objects and group various objects (e.g., grouping motorcycles, traffic cones, delivery trucks, or traffic signs, etc.). Of course, an interval of 3D data points used to output a GT bounding box may also be set, and one GT bounding box may be set to include between 50 to 1000 LiDAR cloud points.

Of course, the GT annotation may not exist in raw data captured by sensors such as the LiDAR 120 while the vehicle is driving. The processor 110 may have to recognize objects belonging to various classes, such as a road sign, a crosswalk, a pedestrian, another vehicle, a center lane, a curb, or a construction barrel, etc., as objects, and GT annotation may serve as a means to measure object recognition errors by comparing object determination results recognized by the AI algorithm of the processor 110 with actual outcomes, such as human-labeled reference data. They are sometimes used to evaluate AI performance. The GT bounding box, which is applied to an original image in the form of annotation, may be set manually by a user, but there is also a commercially available GT calculation tool, such as a tool using grid-striding or polygon-based labeling interfaces, etc.

In a case where the AI object recognition module is driven, predicted bounding boxes may also be observed. A result recognized by the processor 110 as an object of a specific class from original image data obtained from the LiDAR sensor 120, etc., may appear in a form of another bounding box similar to the GT bounding box. Unlike the GT bounding box, the predicted bounding boxes may be computational results of an autonomous driving AI. The predicted bounding box may match the GT bounding box, but it may not match the GT bounding box or may not overlap it at all (e.g., due to occlusion, sensor noise, incorrect class labeling, or bounding box misalignment, etc.).

For reference, the predicted bounding boxes alone may not definitively determine that an object of a specific class actually exists at a certain position, so the predicted bounding boxes may be usually called P-Boxes (probability boxes) or predicted bounding boxes.

Segmentation processing performed after preprocessing refers to, for example, displaying a specific part of a road (e.g., a traffic light) in red and the rest (asphalt road) in blue (e.g., lane markings in yellow, sidewalks in green, or curbs in orange, etc.). Clustering point clouds into certain groups and generating P-Boxes may also be done at the segmentation operation. For reference, there exists a technique called cluster expansion, where an expansion target may include all points within an epsilon distance (a minimum distance constituting a cluster) from a seed point (e.g., 0.5 m, 1 m, or 2 m depending on object density, etc.).

During segmentation processing, clustering and P-Box generation may be performed based on a point cloud. In short, an AI network performing segmentation is used to obtain a point label from the LiDAR sensor 120 (e.g., to identify a tree, signpost, or parked car, etc.).

In the present disclosure, a “rule-based” road surface recognition and label fusion technique may be proposed to solve a problem of ground recognition errors occurring during segmentation. Such road surface recognition algorithms may apply any of a variety of techniques, including slope-based road surface recognition, grid-based road surface recognition, and other non-planar-based road surface recognition (e.g., curvature-based, texture-based, or edge-detection-based techniques, etc.). However, the present disclosure proposes to adopt a slope-based road surface recognition technique in a case of recognizing a road surface inside a tunnel (e.g., due to dim lighting, limited LiDAR returns, or flat tunnel geometry, etc.).

For reference, semantic segmentation indicates a task of assigning a unique class label to each point in a point cloud generated by the LiDAR 120. Semantic segmentation in LiDAR image processing is a technique used to determine and utilize meaningful information from LiDAR data for object recognition or scene reconstruction, which are essential for implementing autonomous driving, and various semantic segmentation AI models already exist, such as a projection-based method, a point-based method, and a sparse convolution-based method (e.g., Cylinder3D, RandLA-Net, or PointPillars, etc.). For example, a result of semantic segmentation may be an outcome of AI computations performed by the processor 110 using a NVIDIA DRIVE™ AGX system, and through such a configuration, various colors may be added to a LiDAR point cloud image.

After the segmentation process as above, the LiDAR image may go through a process called postprocessing. The postprocessing refers to converting point cloud data into 3D maps or modeling, which are meaningful information for autonomous driving (e.g., for localization, path planning, or behavior prediction, etc.). Postprocessing may also include a process of finally removing noise and errors from the LiDAR point cloud image, recognizing objects such as vehicles and pedestrians from the point cloud, and, if necessary, registering point cloud information by attaching a unique identifier thereto (e.g., object ID, timestamp, or class index, etc.).

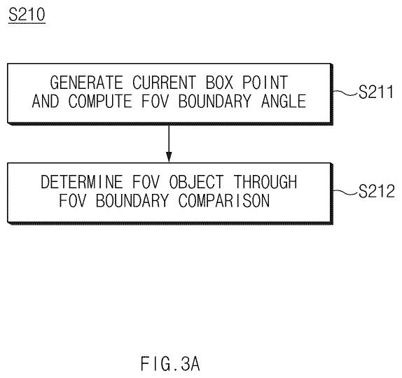

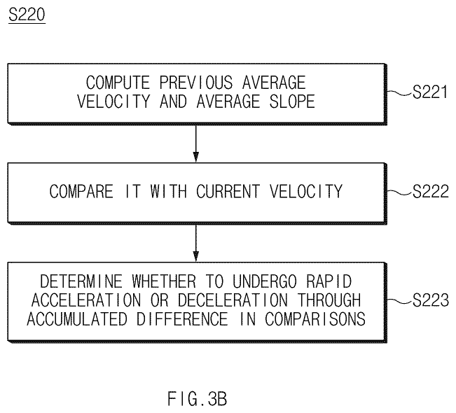

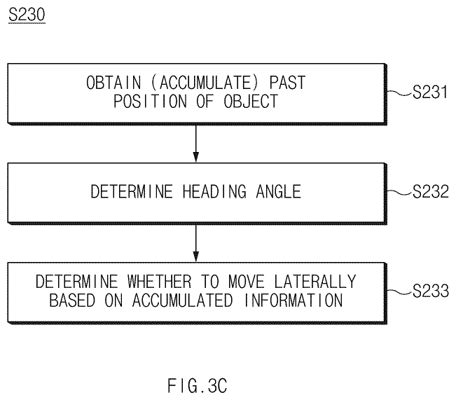

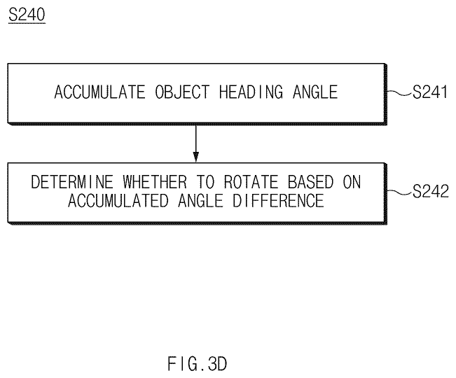

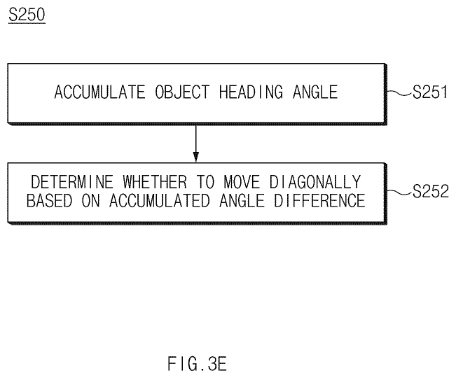

Next, FIG. 2 shows an example overall AI object tracking algorithm 200 that considers a driving situation. A core algorithm of the present disclosure will be described with reference to FIG. 2, and FIGS. 3 to 8b will be referred to as necessary.

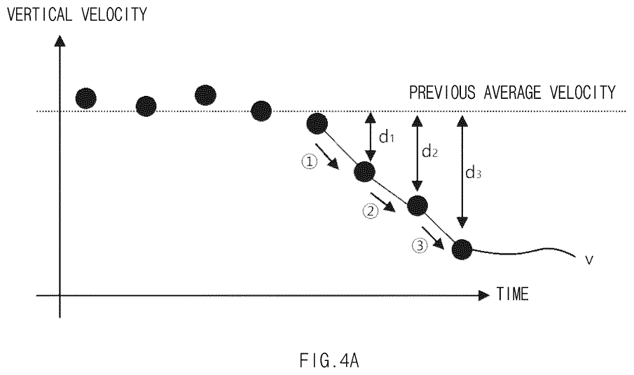

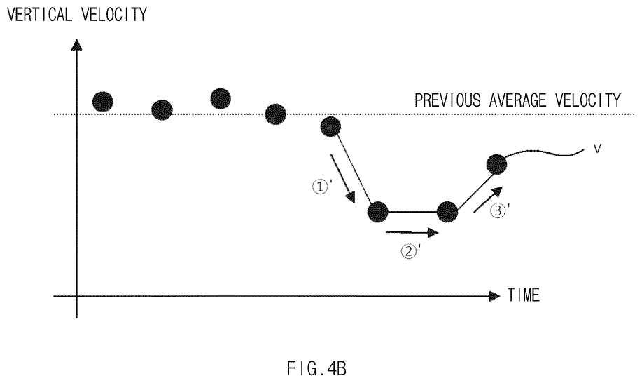

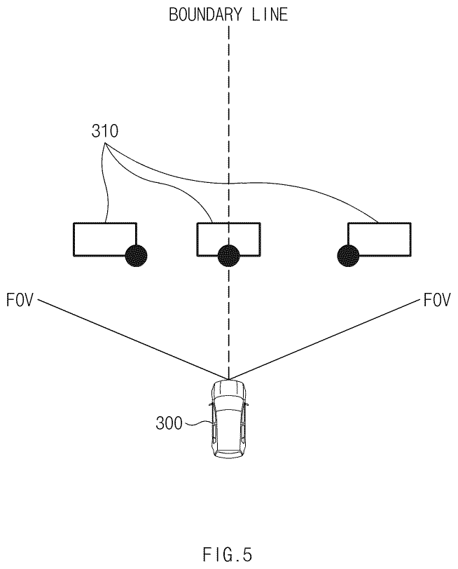

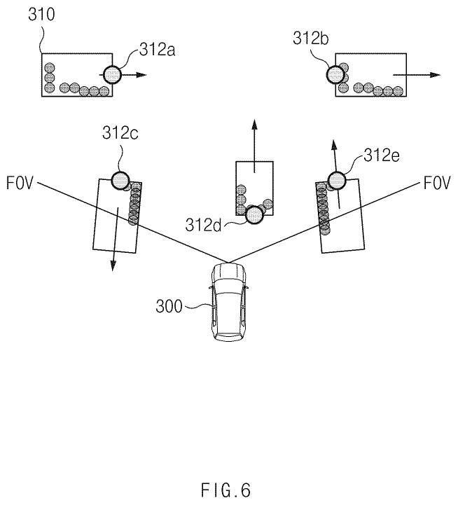

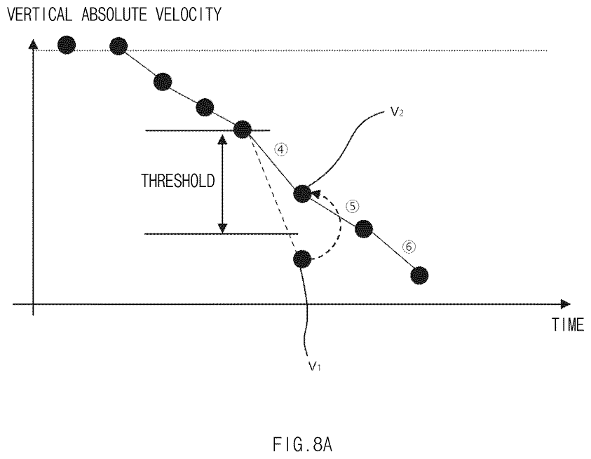

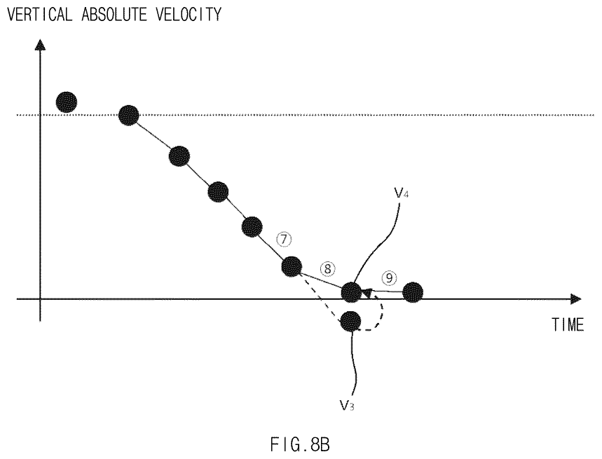

For example, FIG. 3A, FIG. 3B, FIG. 3C, FIG. 3D, and FIG. 3E shows exemplary algorithms for determining several special driving situations. FIG. 4A and FIG. 4B show example views for describing a method for determining a special driving situation of rapid acceleration and deceleration (e.g., sudden speeding after a stoplight or abrupt braking before a crosswalk, etc.). FIG. 5 shows an example of a method by which a representative point used for displacement computation of an object changes in a special driving situation in which the object is traveling in a horizontal direction (e.g., lane changes or overtaking, etc.). FIG. 6 shows an example method of selecting a representative point used for displacement computation of an object in general special driving situations (e.g., diagonal motion or motion near field-of-view boundaries, etc.). FIG. 7 shows an example method of selecting a representative point used for displacement computation of an object in some special driving situations. FIG. 8A and FIG. 8B show an example method for correcting a velocity determination error that may occur for an object undergoing rapid acceleration or deceleration (e.g., stop-and-go traffic or emergency braking, etc.).

First, referring to FIG. 2, a system 1000 for recognizing and tracking an object by an AI module and an autonomous driving sensor 120 according to the present disclosure may include a processor 110 equipped with the AI module for recognizing and tracking an object in a surrounding environment from a plurality of point data input from the autonomous driving sensor; and a memory 130 for storing the plurality of input point data.

In Operation S100, the AI module according to the present disclosure may receive current velocity information measured for objects (particularly, other vehicles) existing around a vehicle undergoing autonomous driving through the autonomous driving sensor 120 (e.g., a LiDAR, radar, or camera, etc.).

In Operation S200, particularly in a case where the object is a vehicle, it may be determined whether a driving situation of the object is a normal driving situation or a special driving situation.

In Operation S200, as one of the core logics of the present disclosure, the present disclosure may present five special driving situations that may affect a velocity logic and proposes a displacement determination method for each situation to reduce shape errors in object tracking (e.g., distorted bounding boxes, jittery object trails, or inaccurate velocity vectors, etc.). In particular, the present disclosure proposes a detailed determination method for a frequently occurring and dangerous special driving situation called sudden acceleration and deceleration (e.g., stop-and-go traffic, abrupt highway merging, or emergency braking, etc.), and a method for reducing velocity determination errors in a sudden acceleration and deceleration situation.

In short, the present disclosure may focus on defining several special driving situations that are problematic in a case of applying conventional techniques and designing a logic capable of determining each special situation to separate the special driving situations, for a velocity stabilization technique for stabilizing a velocity of an object, which is a vehicle having an unstable velocity (e.g., inconsistent acceleration in congested roads or near intersections, etc.), and a method for further improving the same.

In the conventional techniques, in a case where the velocity of an object is unstable, a method of stabilizing it may be to set a target based on velocity and then apply a stabilization technique. However, in such a case, applying a stabilization technique actually may hinder velocity estimation in, e.g., a (special) driving situation where an actual velocity of an object (vehicle) changes rapidly (e.g., overtaking on a curve or rapid merging, etc.). Particularly, for objects undergoing rapid acceleration or deceleration, a rate of velocity change is highly significant and occurs quickly; however, in a case where a stabilization technique is applied, even a timing of velocity information updates may become delayed. This may also be related to performance degradation of a velocity logic, a defense logic for special situations was needed, which led to conception of the present disclosure.

Specifically, the present disclosure may define a special driving situation that affects the aforementioned velocity stabilization technique, analyze characteristics of each special driving situation, and enable robust velocity estimation through shape information and update logic suitable for each special driving situation, thereby overcoming limitations of existing velocity stabilization techniques and enhancing a stability of a velocity logic.

Furthermore, the special driving situation defined in this way may be extended to purposes other than velocity determination, and it may be expected that using environmental information determined in advance according to the present disclosure may also help improve performance of an object tracking logic other than velocity determination (e.g., path prediction, collision avoidance, or trajectory smoothing, etc.).

The special driving situations highlighted in this disclosure may include movement across a field of view (FOV, a range or field of view measured by the autonomous driving sensor toward a front of the autonomous vehicle), lateral movement (i.e., transverse motion), rotational movement, diagonal movement, and rapid acceleration or deceleration, as examined in FIG. 3A, FIG. 3B, FIG. 3C, FIG. 3D, and FIG. 3E (e.g., a vehicle merging at high speed, swerving around an obstacle, or rotating into a parking spot, etc.). In a case of a normal driving situation, it may be determined that the object is unstable in velocity as before, and an accurate predicted displacement may be estimated to update the velocity. Furthermore, in the present disclosure, in a case where it is determined to be a special driving situation, the velocity may be updated by estimating an accurate displacement for each situation without passing through the velocity stabilization technique. In such case, an update rate of the computed velocity may also change based on the special driving situation. The present disclosure may propose a velocity stabilization technique that reduces velocity estimation errors for an object with an unstable velocity by introducing a new process as described above (e.g., bypassing smoothing filters or adjusting update intervals, etc.).

For a more detailed description of Operation S200, FIG. 2 and FIG. 3A to FIG. 3E may be referred to.

In Operation S210, it may be determined whether the object vehicle to be tracked is driving across the field of view (FOV). Referring to FIG. 3A, more specifically, in Operation S211, a P-Box and related LiDAR points for the object vehicle that is currently being tracked may be generated, and a FOV boundary angle may be determined. The FOV boundary angle may refer to an angle between FOV lines extending left and right in FIG. 5, for example (e.g., approximately +45 degrees from the vehicle's forward direction, etc.). In Operation S212, it may be determined whether it is a “FOV special driving situation” by comparing the FOV boundary and a position of the current object (e.g., whether part of the object's bounding box extends beyond the sensor's effective angle, etc.).

For an object positioned along the FOV boundary, shape information may continuously change, which may result in instability in velocity estimation; accordingly, in Operation S210, an object may be classified as an FOV object in a case where a portion of its P-Box points falls within the FOV boundary (e.g., near the corners or edges of a sensor's range, etc.; see, for example, FIG. 5).

In a case where a NO determination is made in Operation S210, Operation S220 may determine whether the object vehicle being tracked is rapidly accelerating or decelerating. Referring to FIG. 3B, for this purpose, the present disclosure may first determine a previous average velocity and an average slope or a heading of the object in Operation S221, then compare the determination result with a current velocity of the object (which was input in Operation S100) in Operation S222, and finally determine whether the object is undergoing rapid acceleration or deceleration in Operation S223 based on an accumulated difference in comparisons (e.g., by checking whether the velocity difference exceeds a preset threshold over a defined time window, etc.).

As described above, in a case of applying the velocity stabilization technique according to the prior art, it may have an opposite effect for a vehicle undergoing rapid acceleration and deceleration (e.g., during sudden lane changes, evasive maneuvers, or stop-and-go driving, etc.), and in the case of a rapid change in velocity such as rapid acceleration, there may be a concern that the velocity update for the object may be delayed. In this case, there may be a difference between the currently updated track box and velocity information and the actual P-Box information, which may deteriorate velocity detection performance (e.g., causing lag in object prediction or incorrect motion modeling, etc.). Accordingly, the present disclosure may introduce Operation S220.

Herein, FIG. 4A and FIG. 4B may be referred to. A vertical axis of graphs shown in FIG. 4A and FIG. 4B represents a longitudinal velocity of a vehicle on a road, and a horizontal axis represents a passage of time (e.g., seconds or milliseconds, etc.). As illustrated in FIG. 4A, according to the present disclosure, a previous average velocity of a vehicle undergoing rapid acceleration or deceleration may be used as a kind of reference (indicated by a dotted line). Compared to other sections, it may be observed that a velocity of the vehicle object measured in sections \textcircled{1}, \textcircled{2}, and \textcircled{3} deviates by d₁, d₂, and d₃ from a previous average velocity, which serves as the reference. In a case where any one of d₁, d₂, or d₃ exceeds a predefined threshold velocity in the present disclosure (for example, assuming that a difference in d₁ surpasses the threshold velocity), FIG. 4A indicates that a difference between a previous average velocity and a current velocity of the object has accumulated over three or more sections beyond the certain threshold velocity. For example, in the instant case, the present disclosure may determine in Operation S220 that the object is in a sudden acceleration or deceleration situation, and may assign flag information to the object notifying that a sudden acceleration or deceleration determination has been made. For reference, although FIG. 4A mentions the longitudinal velocity, a situation in which the lateral velocity exceeds a certain threshold over three or more consecutive sections (e.g., sharp lane change, swerving, or abrupt merging, etc.) may also be classified as rapid acceleration or deceleration, and in such a case, the classification may be further refined by assigning a flag of ‘1’ for the rapid acceleration or deceleration in a longitudinal direction and a flag of ‘2’ for this case in a lateral direction.

Furthermore, it may be possible to check a level of sudden acceleration or deceleration of an object by computing a time at which a sudden acceleration or deceleration situation flag was assigned. This is because in a case of extremely rapid acceleration or deceleration, a special logic may be required for displacement measurement (e.g., updating representative point position or modifying velocity estimation strategy, etc.).

For example, in a case where the sudden acceleration or deceleration is detected but start of the sudden acceleration or deceleration or a change in slope is gentle, it is classified as a first level of an acceleration-deceleration boundary, whereas in a case where the sudden acceleration or deceleration continues for five or more sections or exhibits a steep slope change (e.g., more than 15 m/s² or within 1 second duration, etc.), it is classified as a second level of the acceleration-deceleration boundary to distinguish severity of the sudden acceleration or deceleration.

However, for example, as shown in FIG. 4B, in a case where the velocity increases to a threshold velocity or higher in section \textcircled{1}′, but becomes gentle in section \textcircled{2}′, and there is no significant change in velocity in section \textcircled{3}′, the situation in FIG. 4B will be determined as NO in Operation S220.

Next, in a case where a NO determination is made in Operation S220, Operation S230 may determine whether a tracking target is a vehicle moving horizontally. Referring to FIG. 3C, for this purpose, the present disclosure may accumulate past position information of the object in Operation, determine a heading angle of the object in Operation S232, and evaluate whether the tracked object is moving laterally (i.e., transverse movement) in Operation S233 based on the information obtained in Operations S231 and S232 (e.g., identifying lane changes, drift patterns, or sideway movement near intersections, etc.).

The reason for introducing Operation S230 in the present disclosure is that in a case where an object moves in a horizontal direction, a position of a representative point for displacement computation may change based on an observation angle and an observation position (e.g., left or right camera perspective, edge-of-FOV angle, or LiDAR tilt bias, etc.), which may cause an error in displacement computation. Herein, the representative point may be a point set somewhere in the P-Box to compute a P-Box displacement, which may be more clearly understood by referring to FIG. 5.

Referring to FIG. 5, the FOV boundary can be confirmed based on a host vehicle 300 equipped with the autonomous driving sensor 120. Furthermore, a virtual boundary line that perpendicularly extends through the host vehicle 300 is indicated by a dotted line, and in a case where a vehicle 310 that is currently being tracked exists in three positions shown in FIG. 5, the representative point may change to a lower right point 311a of the P-Box 310, a center point 311b of a lower long side, a lower left point 311c, or an intermediate edge point between adjacent corners, etc. For example, it may be understood from FIG. 5 that lateral movement is a factor that complicates displacement and velocity estimation.

Accordingly, in the present disclosure, in a case where the heading of the object 310 exceeds a certain angle as shown in FIG. 5 and its accumulated positions (three positions marked with reference number 310) consistently indicate lateral movement, the object may be determined as a laterally moving object with a YES determination in Operation S230.

In a case where a NO determination is made in Operation S230, Operation S240 may determine whether a tracking target is a vehicle in a rotational motion. Referring to FIG. 3D, for this purpose, the present disclosure may accumulate and store heading angle information of the object in Operation S241, then determine whether the tracked object is undergoing rotational movement, such as a U-turn, a roundabout rotation, left turns, right turns, or other types of rotation, based on the accumulated angle difference information in Operation S242.

For example, in a case where the tracked vehicle 310 undergoes rotational movement, a position of the representative point for displacement computation varies based on the observation angle, and in the instant case, both lateral and longitudinal velocities may be recognized to change rapidly. Accordingly, in Operation S240, in a case where a certain difference persists between the accumulated heading angles, for example, in a case where the heading angle continues to increase or decrease (e.g., a consistent change greater than a reference threshold like, ±15°, ±30°, or ±45°, etc.)), a YES determination may be made in Operation S240.

In a case where a NO determination is made in Operation S240, Operation S250 may determine whether the tracked vehicle is moving diagonally. Referring to FIG. 3E, for this purpose, the present disclosure may accumulate and store heading angle information of the object in Operation S251, then determine whether the tracking target object is moving diagonally (in other words, moving in a diagonal direction with respect to the host vehicle) (i.e., in a direction forming a non-zero angle with both the longitudinal and lateral axes of the host vehicle, such as ±30°, ±45°, or ±60°, etc.) based on the accumulated angle difference information in Operation S252.

Diagonal movement may be a state of movement in which both a vertical velocity component and a horizontal velocity component exist, and in particular, in a case of a vehicle suddenly cutting in while it is driving on a road (i.e., a cut-in situation), the cutting-in vehicle may mostly moves diagonally, which may directly lead to a safety accident, such as a lane departure, a blind spot collision, or a rear-end crash, etc. So in the present disclosure, it was determined that it is necessary to sensitively update the velocity of such vehicles.

Accordingly, in a case where the accumulated heading angle at Operation S250 maintains a constant angle and a difference between the accumulated heading angles remains below a constant threshold angle (e.g., ±3°, ±5°, or ±7°, etc.) indicating that the vehicle continues to drive while maintaining a constant diagonal angle, the object may be determined as YES as a special driving situation of diagonal driving at Operation S250.

In a case where a YES determination is made at Operation S250, the process may move to Operation S260, where the displacement is updated based on a special situation-tailored displacement computation method according to the present disclosure.

In a case where a NO result is received at Operation S250, the process may move to Operation S300 to determine whether the velocity of the object is stable (e.g., constant speed on a highway, low fluctuation in city driving, or consistent cruising in traffic, etc.). In a case where the object velocity is determined to be stable at Operation S300, the process may move to Operation S900 to perform object tracking while maintaining the velocity that is input at Operation S100 as a current object velocity.

In short, in a case of determining that a normal driving situation is determined by receiving a NO determination in all of operations S210 to S250, the AI module according to the present disclosure may additionally determine in Operation S300 whether the velocity of the object is beyond a predetermined range (i.e., whether the velocity is stable) (e.g., ±2 m/s, ±5 km/h, or ±10%, etc.), and for the object whose velocity is beyond the predetermined range, it moves to Operation S400 to execute an additional displacement estimation process and then update displacement information and velocity information for the object.

In Operation S400, a displacement may be determined from the P-Box shape 310 of the object to estimate the velocity of the object (during normal driving), and in Operation S500, a difference with the predicted displacement may be compared, and then, in a case where it is determined in Operation S600 that the displacement satisfies a condition to which Equation 1 below may have to be applied (e.g., when prediction error exceeds a threshold, when noise is detected, or when confidence score drops, etc.), displacement information may be updated in Operation S700 using the displacement after applying Equation 1, and in Operation S800, a velocity that is different from that input in Operation S100 may be computed and updated.

In short, Operations S700 and S800 may be operations in which a process of updating displacement information and velocity information for the object is executed based on the displacement determined by the displacement estimation process (e.g., estimated from the P-Box shift, centroid shift, or corner point shift, etc.).

Of course, in a case where there is no need to apply Equation 1 (e.g., when the predicted and observed displacements are within tolerance or tracking confidence is high, etc.), a NO determination may be made in Operation S600, followed by moving to Operation S900, where the current velocity is used as is.

For example, the present disclosure may use a velocity stabilization technique using the following Equation 1 in Operations S260 and S700. For example, the velocity Vₜ at the current time point t may be computed according to the following Equation 1.

$${V}_{t} = mean ( {V}_{t - n : t - 1} ) \times α + {\hat{V}}_{t} \times ( 1 - α ) \qquad ( Equation 1 )$$

Herein, \hat{V}ₜ indicates the current velocity computed based on displacement, mean(V_{t-n:t-1}) indicates the average velocity at a previous time point (t−1), n indicates a number of velocity computations performed for average velocity determination, and α indicates a weighting factor (e.g., a velocity update ratio) at the previous time point (t−1) and is a value between 0 and 1.

In Operation S700, in a case where the object is in a general driving situation, the displacement estimation process specialized for this condition may measure a displacement based on a rear center point relative to a travel direction of the object (e.g., center of the rear edge, geometric midpoint of rear corners, or rear-facing centroid, etc.), and may set a weighting factor (e.g., a parameter a to, for example, 0.2, etc.). For example, in a case of FIG. 6, reference numerals 312b, 312c, and 312d may represent cases where a reference for displacement measurement is set in this manner.

For example, in a case of Operation S700, in a normal driving situation, the center point of the P-Box at the rear of the travel direction may be used, but even in normal driving, in a case where it is moving laterally (i.e., reference numeral 312e in FIG. 6) or recognized as moving the FOV (i.e., reference numeral 312a in FIG. 6), a center point of the travel direction may need to be used. In the normal driving condition, a velocity update ratio proposed by the present disclosure may be 0.2 (e.g., a range between 0 and 1 such as 0.1, 0.15, or 0.25, etc.). However, setting the velocity update based on a fixed point and a fixed ratio may result in an inaccurate displacement computation in a special situation (e.g., sudden cut-in, sharp turning, or side-slip, etc.), so Operation S260 may exist.

Operation S260 is an operation where a so-called “special situation tailored displacement computation” process is applied in a case where any one of Operations S210 to S250 is determined as YES (e.g., FOV boundary interaction, sudden speed change, or abnormal trajectory, etc.). For better understanding and ease of description, in a case of the special driving situation, the object may be defined as Type 1 in response to a case where it moves across a field of view (FOV), Type 2 in response to a case where it undergoes rapid acceleration or deceleration, and Type 3 in response to a case where it moves laterally. Furthermore, (iv) in a case where the object is rotating and moving, it is defined as a 4th type, and (v) in a case where the object is moving diagonally (e.g., during cut-in, merging, or evasive maneuvers, etc.), it is defined as a 5th type.

In Operation S260, the “tailored” displacement estimation process for the first type is a first process that computes a displacement using a point at an upper side of a side surface of the P-Box of an object closest to the autonomous driving sensor (e.g., upper left corner, side midpoint, or top edge centroid, etc.).

Herein, FIG. 7 may be referred to. As described above, FIG. 7 shows an example method of selecting a representative point used for displacement computation of an object in some special driving situations.

In Operation S260, for the first type, the displacement may be computed using the upper side point close to the host vehicle 300, as this is A most stable point observed from the beginning. For example, reference numerals 313b and 313c in FIG. 7 may be examples of the first type, and instead of points reference numbers 313a and 313d, displacement measurement reference points to be applied in the first type may be selected from the upper corner or upper center region of the P-Box (e.g., points of reference numerals 313b, 313c, or an upper midpoint, etc.). However, in a case of the first type, the present disclosure may suggest performing setting of α=0.2.

Next, in Operation S260, the “tailored” displacement estimation process for the second type may be a second process that computes a displacement of the object based on a rear point of the P-Box of the object.

For example, in a case of rapid acceleration or deceleration driving, the object and observed shape are similar to those in a general driving situation, so the displacement may be computed using the rear point; however, because a vehicle variation may be significant in the rapid acceleration or deceleration driving, a newly observed vehicle's velocity should be more heavily weighted (e.g., a reflection ratio of a new vehicle may have to be higher).

Accordingly, in the present disclosure, in Operation S260, in response to applying the “tailored” displacement estimation process for the second type, it may be proposed that a value a for Equation 1 be set to 0.1 (e.g., for a short-duration or low-slope acceleration event) in a case of a first level of the rapid acceleration-deceleration boundary and 0.01 (e.g., for a prolonged or steep-slope deceleration event) in a case of a second level.

In short, in the sudden acceleration or deceleration situation, an algorithm in Operation S260 may be set to compute the displacement of the object based on the rear point of the P-Box (e.g., a rear center point, a rear corner point, or a rear edge midpoint, etc.), and after updating the displacement in Operation S700, Operation S800 may derive a current Vₜ to be applied in step S800 by significantly reflecting \hat{V}ₜ which is computed based on a newly reflected displacement from Operations S260 and S700.

However, it may be necessary to refer to FIGS. 8A and 8B herein. For example, in the present disclosure, in Operation S260, in response to applying the “tailored” displacement estimation process for the second type, in a case where the updated velocity information Vₜ deviates from a predefined threshold even after recognizing the driving situation as rapid acceleration or deceleration, a process may be conducted to correct the velocity exceeding the threshold to fall within the threshold based on the object's velocity and slope information prior to the measurement of the deviating velocity (e.g., by referencing the most recent non-outlier velocity, average slope trend, or historical trajectory data, etc.), as illustrated in FIG. 8A.

In FIG. 8A, for example, in sections \textcircled{4}, \textcircled{5}, and \textcircled{6}, a velocity difference at a level of d₁, as illustrated in FIG. 4A, has occurred, so it may be determined as the rapid acceleration or deceleration situation. However, according to the present disclosure, this indicates that a velocity v₁ in section \textcircled{4}, which exceeds even the predefined threshold (as shown in FIG. 8A), may have to be corrected to v₂ (e.g., based on pre-deviation data, historical slope change, or median velocity, etc.), as illustrated in FIG. 8A.

For example, in FIG. 8A, in the rapid acceleration or deceleration driving situation, the updated velocity Vₜ may be determined to have at least the value v₁ as an error, and an algorithm may be added to mitigate this

In a case where the error v₁ occurs, it may be corrected to v₂ using the velocity and slope prior to the occurrence of v₁.

Furthermore, in the present disclosure, in a case where absolute velocity information of the velocity updated by a third operation after recognizing the driving situation as the rapid acceleration or rapid deceleration is 0 meters per second (mps) or less, a process of correcting the absolute velocity of 0 mps or less to the absolute velocity exceeding 0 mps may be performed based on the velocity information and slope information about the object at a time point before the absolute velocity of 0 mps or less is measured, and an example of this process is illustrated in FIG. 8B. Such adjustment may apply, for instance, in cases where a momentary stop or occlusion falsely results in 0 mps, as seen when the object is partially hidden, momentarily paused, or visually obstructed (e.g., at intersections, behind poles, or due to low LiDAR reflectance, etc.).

In FIG. 8B, for example, among sections \textcircled{7}, \textcircled{8}, and \textcircled{9}, a velocity v₃ in section \textcircled{8}, which falls below another predefined threshold (e.g., 0 mps, as shown in FIG. 8B) according to the present disclosure, may have to be corrected to v₄, as illustrated in FIG. 8B. It should be noted that the vertical axis in FIG. 8b represents ‘absolute velocity.’

In a case where the error v₃ occurs, it may be corrected to v₄, which exceeds 0 mps, using the velocity and slope prior to the occurrence of v₃.

Finally, in Operation S260, the “tailored” displacement estimation process for the third type to the fifth type may be applied as a third process for computing a displacement of the object based on a point that is closest and most stable to a virtual line extending through a center of a vehicle equipped with the autonomous driving sensor in a front driving direction of the vehicle among the points forming vertices of the P-Box for the object (e.g., front-left vertex, front-right vertex, center-front midpoint, or lower-front midpoint, etc.).

For example, in a case of rotation movement of the fourth type in FIG. 7, reference numeral 313e may be selected as the reference for displacement determination for the object 310 (e.g., during a U-turn, a roundabout maneuver, or a lane-change with yaw rotation, etc.).

For reference, in Operation S260 of the present disclosure, in response to applying the “tailored” displacement estimation process for the third type, it may be additionally proposed that the value a for Equation 1 be set to 0.4 for Type 3 (lateral movement), 0.5 for Type 4 (rotational movement), and 0.3 for Type 5 (diagonal movement) (e.g., lane merges, overtaking maneuvers, or angled crosswalk entries, etc.).

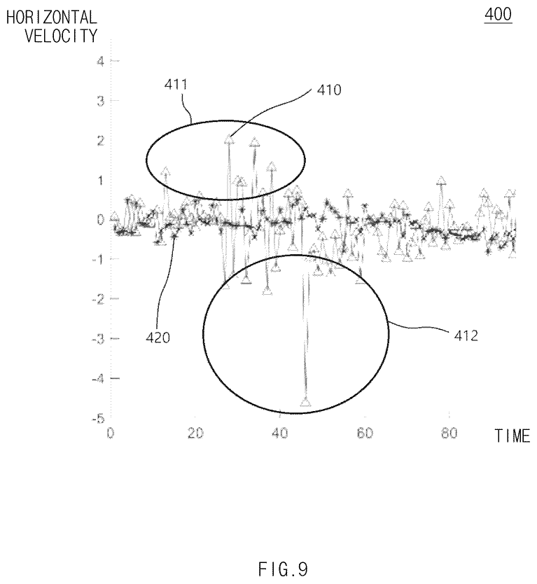

FIG. 9 shows an exemplary experimental result showing that tracking performance for a horizontal velocity of an object is improved in a case where an example of the present disclosure is actually applied.

In FIG. 9, a vertical axis indicates a value that tracks the horizontal velocity of the object 310 (e.g., a vehicle changing lanes, a pedestrian walking across the road, or a bicycle moving sideways, etc.), and horizontal axis represents a flow of time. As may be seen in FIG. 9, a velocity estimation result 410 according to the conventional art includes many outliers such as reference numerals 411 and 412 (e.g., spikes or dips due to misclassification or occlusion, etc.), whereas a velocity measurement result 420 according to the present disclosure may have almost no outliers.

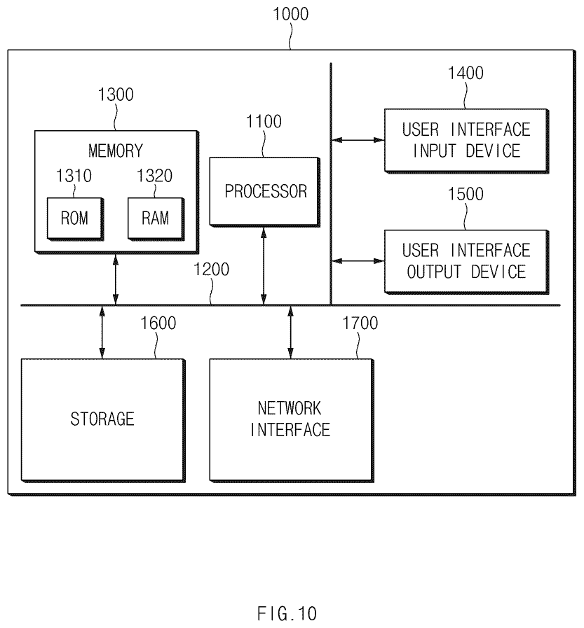

FIG. 10 shows an example computing system 1000 for autonomous vehicle control and object recognition computation.

Referring to FIG. 10, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media (e.g., flash memory, solid-state drives (SSDs), magnetic disks, or phase-change memory, etc.). For example, the memory 1300 may include a read only memory (ROM) and a random access memory (RAM) (e.g., DRAM, SRAM, or LPDDR, etc.).

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., SSD, USB drive, or optical media).

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., an onboard vehicle controller or mobile computing platform). Alternatively, the processor and the storage medium may reside as separate components within the user terminal.

An example of the present disclosure relates to an AI object tracking system for recognizing and tracking an object using an AI module and an autonomous driving sensor, including a processor configured to include the AI module that recognizes and tracks an object in a surrounding environment from multiple point data input from the autonomous driving sensor; and a memory configured to store the input multi point data, wherein the AI module performs a first operation of determining whether a driving situation of the object is a normal driving situation or a special driving situation in a case where the object is a vehicle, a second operation of executing a displacement estimation process tailored to a detailed type of the special driving situation or specialized for the general driving situation in a case where the special driving situation or the general driving situation has been determined, and a third operation of updating displacement information and velocity information for the object based on a displacement determined by the displacement estimation process.

In a case of an AI object tracking system that considers a driving condition according to an example of the present disclosure, the AI module further may perform a fourth operation of additionally determining whether a velocity of the object is beyond a predetermined range in response to determining that the driving situation is the general driving situation, and executing an additional displacement estimation process for the object whose velocity is beyond the predetermined range, and then updating displacement information and velocity information for the object.

In a case of an AI object tracking system that considers a driving condition according to an example of the present disclosure, the special driving situation may include at least one of (i) a first type in which the object moves across a field of view (FOV), (ii) a second type in which the object rapidly accelerates or rapidly decelerates, (iii) a third type in which the object is moving laterally, (iv) a fourth type in which the object rotates and progresses, or (v) a fifth type in which the object is moving diagonally.

In a case of an AI object tracking system that considers a driving condition according to an example of the present disclosure, the displacement estimation process may be a first process that computes a displacement using a point at an upper side of a side surface of the predicted bounding box (P-Box) of an object closest to the autonomous driving sensor in a case where the special driving situation is the first type.

In a case of an AI object tracking system that considers a driving condition according to an example of the present disclosure, the displacement estimation process may be a second process that computes a displacement of the object based on a rear point of the P-Box of the object in a case where the special driving situation is the first type.

In a case of an AI object tracking system that considers a driving condition according to an example of the present disclosure, the second process may include a process of correcting a velocity exceeding a predetermined threshold to fall within the threshold based on velocity information and slope information of the object at a time point before measuring the velocity exceeding the threshold, in a case where the velocity information updated by the third operation still deviates from the predetermined threshold even after recognizing the driving situation as the rapid acceleration or rapid deceleration.

In a case of an AI object tracking system that considers a driving condition according to an example of the present disclosure, the second process may include a process of correcting an absolute velocity of 0 mps or less to exceed 0 mps based on the velocity information and slope information of the object at a time point before measuring the absolute velocity of 0 mps or less, in a case where absolute velocity information of a velocity updated by the third operation is 0 mps or less after recognizing the driving situation as the rapid acceleration or rapid deceleration.

In a case of an AI object tracking system that considers a driving condition according to an example of the present disclosure, the displacement estimation process may be a third process for computing a displacement of the object based on a point that is closest and most stable to a virtual line extending through a center of a vehicle equipped with the autonomous driving sensor in a front driving direction of the vehicle among the points forming vertices of the P-Box for the object in a case where the special driving situation is any one of the third to fifth types.

In a case of an AI object tracking system that considers a driving condition according to an example of the present disclosure, a velocity Vₜ at a current time point t, updated by the third operation, ma be computed according to following Equation 1.

$${V}_{t} = mean ( {V}_{t - n : t - 1} ) \times α + {\hat{V}}_{t} \times ( 1 - α ) \qquad [ Equation 1 ]$$

Herein, \hat{V}ₜ indicates the current velocity computed based on displacement, mean(V_{t-n:t-1}) indicates the average velocity at a previous time point (t−1), n indicates a number of velocity computations performed for average velocity determination, and α indicates a weighting factor (e.g., a velocity update ratio) at the previous time point (t−1) and may be a value between 0 and 1.

In a case of an AI object tracking system that considers a driving condition according to an example of the present disclosure, the displacement estimation process specialized for the general driving situation may measure a displacement based on a rear center point relative to a travel direction of the object in a case where the object is in the general driving situation, and the a may be set to 0.2.

An example of the present disclosure relates to an AI object tracking method for recognizing an object using an AI module and an autonomous driving sensor, the method including operations, performed by the AI module, including a first operation of determining whether a driving situation of the object is a normal driving situation or a special driving situation in a case where the object is a vehicle, a second operation of executing a displacement estimation process tailored to a detailed type of the special driving situation or specialized for the general driving situation in a case where the special driving situation or the general driving situation has been determined, and a third operation of updating displacement information and velocity information for the object based on a displacement determined by the displacement estimation process.

As previously discussed from various examples, the present disclosure may be configured to define a general driving situation and a special driving situation and to go through a procedure for determining which driving situation an object to be tracked corresponds to.

Particularly, the present disclosure may present five special driving situations that may affect a velocity logic and proposes a displacement determination method for each situation to reduce shape errors in object tracking. In particular, the present disclosure proposes a detailed determination method for a frequently occurring and dangerous special driving situation called sudden acceleration and deceleration, and a method for reducing velocity determination errors in a sudden acceleration and deceleration situation.

In short, the present disclosure may focus on defining several special driving situations that are problematic in a case of applying conventional techniques and designing a logic capable of determining each special situation to separate the special driving situations, for a velocity stabilization technique for stabilizing a velocity of an object, which is a vehicle having an unstable velocity, and a method for further improving the same.

In the conventional techniques, in a case where the velocity of an object is unstable, a method of stabilizing it may be to set a target based on velocity and then apply a stabilization technique. However, in such a case, applying a stabilization technique actually may hinder velocity estimation in, e.g., a (special) driving situation where an actual velocity of an object (vehicle) changes rapidly. Particularly, for objects undergoing rapid acceleration or deceleration, a rate of velocity change is highly significant and occurs quickly; however, in a case where a stabilization technique is applied, even a timing of velocity information updates may become delayed. This may also be related to performance degradation of a velocity logic, a defense logic for special situations was needed, which led to conception of the present disclosure.

Specifically, the present disclosure may define a special driving situation that affects the aforementioned velocity stabilization technique, analyze characteristics of each special driving situation, and enable robust velocity estimation through shape information and update logic suitable for each special driving situation, thereby overcoming limitations of existing velocity stabilization techniques and enhancing stability of a velocity logic.

Furthermore, the special driving situation defined in this way may be extended to purposes other than speed judgment, and it may be expected that using environmental information determined in advance according to the present disclosure may also help improve performance of an object tracking logic other than velocity determination.

The special driving situations highlighted in this disclosure may include movement across a field of view (FOV, a range or field of view measured by the autonomous driving sensor toward a front of the autonomous vehicle), lateral movement (i.e., transverse motion), rotational movement, diagonal movement, and rapid acceleration or deceleration. In a case of a normal driving situation, it may be determined that the object is unstable in velocity as before, and an accurate predicted displacement may be estimated to update the velocity. Furthermore, in the present disclosure, in a case where it is determined to be a special driving situation, the velocity may be updated by estimating an accurate displacement for each situation without passing through the velocity stabilization technique. In the instant case, an update rate of the computed velocity may also change based on the special driving situation. The present disclosure may propose a velocity stabilization technique that reduces velocity estimation errors for an object with an unstable velocity by introducing a new process as described above.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed is:

1. An apparatus of a host vehicle, the apparatus comprising:
a processor; and
a memory storing at least one instruction that, when executed by the processor communicating with the memory, is configured to cause the apparatus to:
obtain multiple point data input from a sensor of the host vehicle,
based on the multiple point data and using an artificial intelligent model, detect and track a vehicle in a surrounding environment of the host vehicle,
determine whether a movement of the vehicle satisfies a normal condition or a special condition,
based on the determination of whether the movement satisfies the normal condition or the special condition, execute one of a first displacement estimation process or a second displacement estimation process, wherein the first displacement estimation process is performed to determine a displacement of the vehicle under the normal condition, and wherein the second displacement estimation process is performed to determine a displacement of the vehicle under the special condition,
based on a displacement of the vehicle determined by the execution of the one of the first displacement estimation process or the second displacement estimation process, output a signal indicating updated displacement information and velocity information for the vehicle, and
control, based on the signal, autonomous driving of the host vehicle.

2. The apparatus of claim 1, wherein the at least one instruction, when executed by the processor communicating with the memory, is configured to cause the apparatus to, based on a determination that the movement of the vehicle satisfies the normal condition,
determine whether a velocity of the vehicle exceeds a predetermined range,
based on a determination that the velocity of the vehicle exceeds the predetermined range, execute an additional displacement estimation process, and
based on the execution of the additional displacement estimation process, update displacement information and velocity information for the vehicle.

3. The apparatus of claim 1, wherein the special condition is at least one of:
a first type in which the vehicle moves across a field of view (FOV),
a second type in which the vehicle accelerates or decelerates at a rate greater than a preset threshold acceleration or deceleration value, respectively,
a third type in which the vehicle is moving laterally,
a fourth type in which the vehicle rotates and progresses, or
a fifth type in which the vehicle is moving diagonally.

4. The apparatus of claim 3, wherein the second displacement estimation process is configured to, based on the special condition being the first type, determine a displacement of the vehicle using a point at an upper side of a side surface of a predicted bounding box (P-Box) associated with the vehicle when the vehicle is an object closest to the sensor.

5. The apparatus of claim 3, wherein the second displacement estimation process is configured to determine a displacement of the vehicle based on a rear point of a predicted bounding box (P-Box) associated with the vehicle.

6. The apparatus of claim 5, wherein the second displacement estimation process is configured to:
based on:
the special condition being the second type,
a velocity value updated by the execution of the second displacement estimation process deviating from a predetermined threshold, and
velocity information and slope information of the vehicle at a time point before the velocity value exceeding the predetermined threshold,
adjust the velocity value that exceeds the predetermined threshold such that the adjusted velocity value falls within the predetermined threshold.

7. The apparatus of claim 5, wherein the second displacement estimation process is configured to:
based on:
the special condition being the second type,
an absolute velocity value updated by the execution of the second displacement estimation process being zero meters per second (mps) or less, and
velocity information and slope information of the vehicle at a time point before the absolute velocity value being zero mps or less,
adjust the absolute velocity value that is zero mps or less such that the adjusted absolute velocity value exceeds zero mps.

8. The apparatus of claim 3, wherein the second displacement estimation process is configured to:
based on a point, among points forming vertices of a predicted bounding box (P-Box) for the vehicle, that is closest and most stable to a virtual line extending through a center of the vehicle, determine a displacement of the vehicle, wherein the sensor is in a front driving direction of the vehicle, and wherein the special condition is one of the third type, the fourth type, and the fifth type.

9. The apparatus of claim 1, wherein
a velocity Vₜ at a current time point t, updated by the one of the first displacement estimation process or the second displacement estimation process, is determined according to Equation 1.
Vₜ=mean(V_{t-n:t-1})×α+\hat{V}ₜ×(1−α) [Equation 1]
wherein, \hat{V}ₜ indicates a current velocity determined based on displacement, mean(V_{t-n:t-1}) indicates an average velocity at a previous time point (t−1), n indicates a number of velocity computations performed for average velocity determination, and α indicates a velocity update ratio at the previous time point (t−1) and is a value between 0 and 1.

10. The apparatus of claim 9, wherein the first displacement estimation process is configured to, based on a rear center point relative to a travel direction of the vehicle and the velocity update ratio being set to 0.2, measure a displacement of the vehicle.

11. A method performed by an apparatus of a host vehicle, the method comprising:
obtaining multiple point data input from a sensor of the host vehicle;
based on the multiple point data and using an artificial intelligent model, detecting and tracking a vehicle in a surrounding environment of the host vehicle;
determining whether a movement of the vehicle satisfies a normal condition or a special condition;
based on the determining of whether the movement satisfies the normal condition or the special condition, executing one of a first displacement estimation process or a second displacement estimation process, wherein the first displacement estimation process is performed to determine a displacement of the vehicle under the normal condition, and wherein the second displacement estimation process is performed to determine a displacement of the vehicle under the special condition;
based on a displacement of the vehicle determined by the execution of the one of the first displacement estimation process or the second displacement estimation process, outputting a signal indicating updated displacement information and velocity information for the vehicle; and
controlling, based on the signal, autonomous driving of the host vehicle.

12. The method of claim 11, further comprising:
based on a determination that the movement of the vehicle satisfies the normal condition, determining whether a velocity of the vehicle exceeds a predetermined range,
based on a determination that the velocity of the vehicle exceeds the predetermined range, executing an additional displacement estimation process, and
based on the execution of the additional displacement estimation process, updating displacement information and velocity information for the vehicle.

13. The method of claim 11, wherein the special condition is at least one of:
a first type in which the vehicle moves across a field of view (FOV),
a second type in which the vehicle accelerates or rapidly decelerates at a rate greater than a preset threshold acceleration or deceleration value, respectively,
a third type in which the vehicle is moving laterally,
a fourth type in which the vehicle rotates and progresses, or
a fifth type in which the vehicle is moving diagonally.

14. The method of claim 13, further comprising:
determining, based on the second displacement estimation process, a displacement of the vehicle using a point at an upper side of a side surface of a predicted bounding box (P-Box) associated with the vehicle when the vehicle is an object closest to the sensor, wherein the special condition is the first type.

15. The method of claim 13, further comprising:
determining, based on the second displacement estimation process, a displacement of the vehicle based on a rear point of a predicted bounding box (P-Box) associated with the vehicle.

16. The method of claim 15, further comprising:
based on:
the special condition being the second type,
a velocity value updated by the execution of the second displacement estimation process deviating from a predetermined threshold, and
velocity information and slope information of the vehicle at a time point before the velocity value exceeding the predetermined threshold,
adjusting the velocity value that exceeds the predetermined threshold such that the adjusted velocity value falls within the predetermined threshold.

17. The method of claim 15, further comprising:
based on:
the special condition being the second type,
an absolute velocity value updated by the execution of the second displacement estimation process being zero meters per second (mps) or less, and
velocity information and slope information of the vehicle at a time point before the absolute velocity value being zero mps or less,
adjusting the absolute velocity value that is zero mps or less such that the adjusted absolute velocity value exceeds zero mps.

18. A vehicle comprising:
a sensor;
a driving control circuit configured to control autonomous driving of the vehicle;
a processor; and
a memory storing at least one instruction that, when executed by the processor communicating with the memory, is configured to cause the vehicle to:
obtain point cloud data from the sensor representing a surrounding environment of the vehicle,
identify an object in the surrounding environment of the vehicle based on the point cloud data using an artificial intelligence model,
identify a movement condition of the object as either:
a normal condition, in which the object travels forward along a travel direction with a velocity and a heading that remain within a predetermined range over a time period, or
a special condition, in which at least one of a velocity or a heading of the object deviates from the predetermined range within the time period,
based on the identified movement condition, execute a displacement estimation process specific to the identified movement condition to determine a displacement and a velocity of the object,
output a signal indicating the displacement and the velocity of the object; and
control, based on the signal, autonomous driving of the vehicle using the driving control circuit.

19. The vehicle of claim 18, wherein the at least one instruction that, when executed by the processor communicating with the memory, is configured to cause the vehicle to:
select, based on the identified movement condition, a representative point of a predicted bounding box of the object from which the displacement is determined,
wherein, in the normal condition, the representative point is a rear center point of the predicted bounding box, and
wherein, in the special condition, the representative point is a point, among vertices of the predicted bounding box, closest to a center line of the vehicle in a front driving direction.

20. The vehicle of claim 18, wherein the at least one instruction that, when executed by the processor communicating with the memory, is configured to cause the vehicle to:
based on a sum of a previously determined average velocity of the object and a current velocity of the object, determine the velocity of the object,
wherein the current velocity is derived, based on a weighting factor, from a displacement of the object,
wherein, in the normal condition, the weighting factor is set to a first value, and
wherein, in the special condition, the weighting factor is set to a second value that is smaller than the first value.
